(19) United States
(12) Patent Application Publication
(10) Pub. No.: US 2025/0328333 A1
(43) Pub. Date: Oct. 23, 2025

(54) MANAGING SPDM FIRMWARE MEASUREMENTS DURING RUNTIME SERVICE INSTALLATION

(71) Applicant: American Megatrends International, LLC, Duluth, GA (US)

(72) Inventor: Chitrak GUPTA, Johns Creek, GA (US)

(21) Appl. No.: 18/638,909

(22) Filed: Apr. 18, 2024

(51) Int. Cl. G06F 8/65; G06F 8/61

(52) U.S. Cl. CPC G06F 8/65; G06F 8/61

(57) ABSTRACT

In an aspect of the disclosure, a method, a computer-readable medium, and an apparatus are provided. The apparatus may be a BMC. The BMC receives, from a requester, a request for a measurement of a firmware component of the BMC. The BMC obtains a current measurement of the firmware component. The BMC retrieves a previous measurement of the firmware component. The BMC sends, to the requester, a response containing the current measurement and the previous measurement of the firmware component.

### BACKGROUND

### Field

The present disclosure relates generally to computer systems, and more particularly, to techniques of managing firmware measurements during runtime service installation at a baseboard management controller (BMC).

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture. The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a BMC. The BMC receives, from a requester, a request for a measurement of a firmware component of the BMC. The BMC obtains a current measurement of the firmware component. The BMC retrieves a previous measurement of the firmware component. The BMC sends, to the requester, a response containing the current measurement and the previous measurement of the firmware component.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system.

FIG. 2 is a diagram illustrating a BMC implementation.

FIG. 3 is a diagram illustrating interactions between a requester and a responder in accordance with an SPDM framework.

FIG. 4 is a diagram illustrating partition format of a BMC.

FIG. 5 is a diagram illustrating a process for verifying firmware integrity.

FIG. 6 is a flow chart illustrating a process for managing SPDM firmware measurements.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

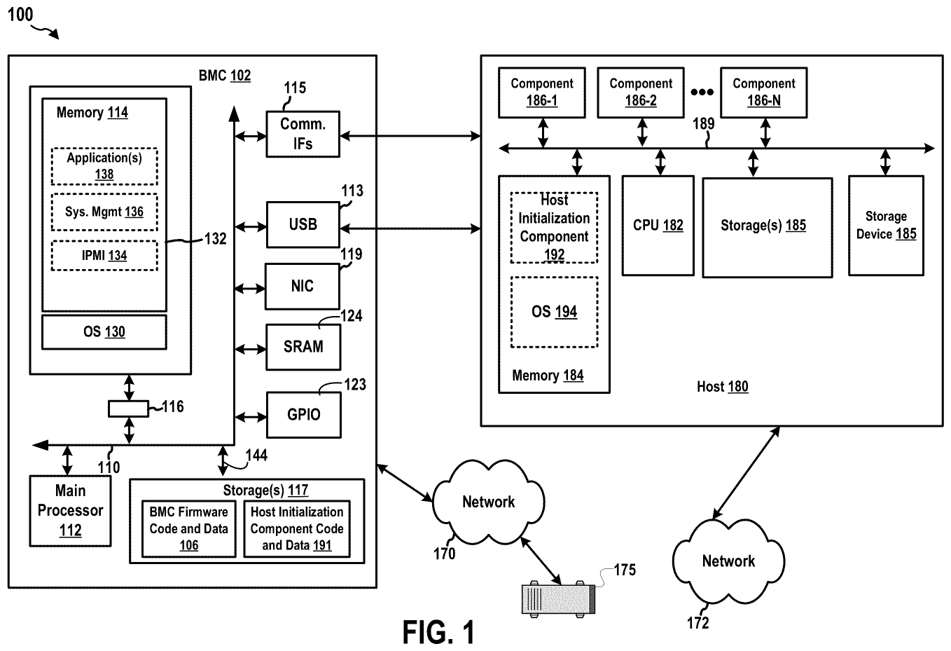

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

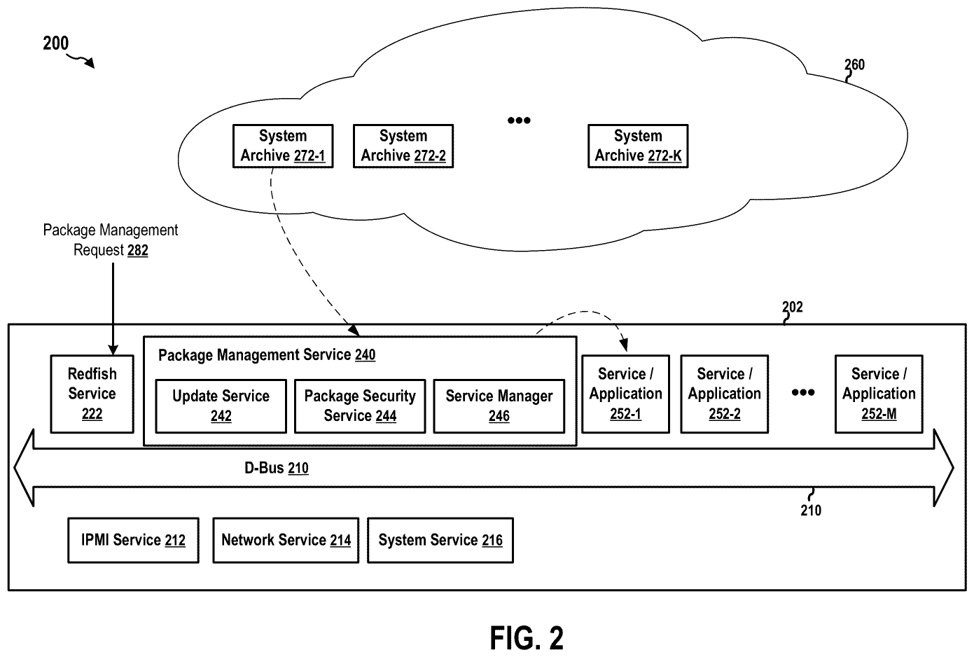

FIG. 2 is a diagram 200 illustrating a BMC implementation. A BMC 202 is an implementation of the BMC 102. The BMC 202 executes, among other services/applications, an IPMI service 212, a network service 214, a system service 216, a REDFISH service 222, a package management service 240, services/applications 252-1, 252-2, . . . , 252-M. A cloud storage 270 stores system archives 272-1, 272-2, . . . , 272-K. Each of the system archives 272-1, 272-2, . . . , 272-K is a secure location where updatable packages of a corresponding service/application (e.g., one of the services/applications 252-1, 252-2, . . . , 252-M) of a BMC are kept. Further, the package management service 240 includes an update service 242, a package security service 244, and a service manager 246.

The REDFISH service 222 serves as the bridge between remote management actions and the BMC 202, enabling cloud-based package management in a secure and standard manner.

The REDFISH service 222 allows external components to interact with and send commands to the BMC 202. The REDFISH service 222 implements a RESTful interface and may utilize standard HTTP(S) and JSON to provide access to data center hardware management functions.

The REDFISH service 222 provides the REDFISH API, which is the mechanism of communication between a remote management console and the BMC 202 for package management-related operations. The operations may include activities such as installing new software, updating existing software, or removing software from the system.

Once the package management commands are sent through the REDFISH interface, they are received by the package management service 240 running on the BMC 202. The package management service 240 is responsible for initiating and managing the actions requested through the REDFISH API calls. In particular, the package management service 240 interacts with the cloud storage 270. It is from this repository that the package management service 240 will fetch the software packages needed for installation or updates.

The package management service 240 of the BMC 202 has the capability to install, remove, and upgrade packages during the runtime of the system. The cloud storage 270 provides packages that can be installed or updated on the BMC 202. Similar to the functionality available in Linux distributions, a user can use package management commands such as “apt install <pkg-name>” to manage (e.g., install, updat, or remove) software packages. This functionality is made possible through the use of the REDFISH Software Installation service of the REDFISH service 222, as described supra.

The package management service 240 supports various package file formats for software deployment within the BMC 202. For example, RPM (Red Hat Package Manager) and DEB (Debian package) may be supported. RPM and DEB are common packaging formats used in Linux distributions for managing individual software packages, which contain the executable, configuration files, and metadata relevant to the software. This conformity to widely adopted packaging standards facilitates interoperability and the use of established tools and practices in package management.

Enterprise systems includes numerous devices, each with mutable components that can be potential vectors for security breaches. Mutable components, by their nature, can be altered or updated, potentially introducing malicious code or unauthorized changes.

The Security Protocol and Data Model (SPDM) Specification enables devices to prove their identity and the integrity of their mutable components, such as firmware code and configuration data, to defend against potential attacks.

In addition to hardware identity, an SPDM-compliant device can be queried to provide firmware identity, referred to as measurements.

Measurements are hash values or bit streams representing the firmware code and configuration data. One device, i.e., a requester, e.g., the BIOS of the host 180, can use the GET_MEASUREMENTS command to request individual or all measurements from another device, i.e., a responder, e.g., the BMC 102. Accordingly, the responder obtains the requested measurements and returns them to the requester. The requester compares the returned measurements to known values, either locally or using a remote attestation server, to determine the integrity of the responder.

Further, an SPDM-compliant device generates or is provisioned with an asymmetric device key pair (i.e., a private key and a public key). The requester can specify whether the measurements need to be signed to verify their origin. The responder uses the private key to sign the response, while the requester uses the public key to authenticate the device-generated signature from the responder.

The SPDM protocol facilitates the measurement of various firmware components to ensure their integrity and authenticity. These measurements can encompass a wide range of targets within the firmware. For example, measurements can be taken on the contents of the SPI flash memory, which often houses critical boot components and firmware images. Measurements can target individual partitions within the EMMC storage, verifying the integrity of specific sections of the firmware or operating system. The root file system, containing essential files and directories for system operation, can be measured to detect any unauthorized modifications or additions.

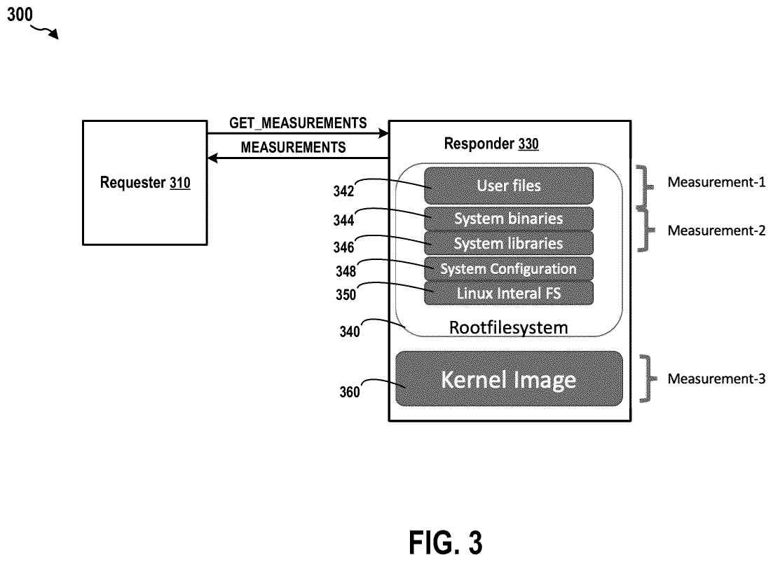

FIG. 3 is a diagram 300 illustrating interactions between a requester 310 and a responder 330 in accordance with the SPDM framework. In this example, the responder 330, e.g., the BMC 102, has various firmware components, each associated with specific functionalities within the system. More specifically, these components are: kernel image 360, root filesystem 340, system configuration 348, linux internal fs 350, system libraries 346, system binaries 344, and user files 342.

Each of these components can be independently measured, which involves generating a hash or a similar cryptographic representation of the component's data. In this example, Measurement-1 is directed to the user files 342. Measurement-2 is directed to the system libraries 346 and system binaries 344. Measurement-3 is directed to the kernel image 360.

The requester 310 initiates the process by sending a GET_MEASUREMENTS command to the responder 330. The responder then computes or retrieves the measurements of the specified components and sends these back to the requester. The measurements may be signed with the responder's private key to ensure their authenticity and integrity during transmission.

Upon receiving the measurements, the requester can verify them against known good values (e.g., values obtained during a secure installation or previous measurements stored securely). This verification process can be performed locally or through a remote attestation service. If the measurements match the expected values, the integrity of the firmware is confirmed, and the system can be trusted to perform its operations securely.

In a typical firmware setup, the image components are part of a read-only filesystem such as SquashFS. Any measurements performed on these components remain static and can be easily verified by the requester. The immutability of the read-only filesystem guarantees the integrity of the measurements.

However, in situations where runtime installation and management of root filesystem files occur, the measurements will continually change. The requester needs a reliable way of determining the correct measurement values, as the filesystem is no longer static. This poses a significant challenge in determining the integrity and trustworthiness of the system.

A requester and a responder can be any two devices, including BMC, GPU, FPGA, SmartNICs, HROT chips, and storage controllers. Additionally, a requester can also be a software or firmware component, such as BIOS or the host operating system. The host operating system, for example, may query the devices for measurements to verify the sanity of the data. This highlights the importance of maintaining accurate and reliable measurements, even in the face of dynamic changes to the filesystem.

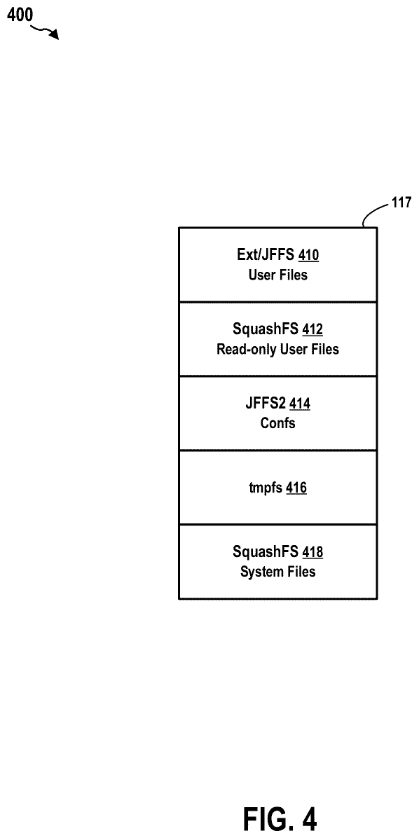

FIG. 4 is a diagram 400 illustrating partition format of a BMC. In this example, the storage(s) 117 of the BMC 102 may include an Ext/JFFS partition 410, a SquashFS partition 412, a JFFS2 partition 414, a tmpfs partition 416, and a SquashFS partition 418. The Ext/JFFS partition 410 may contain user files. The SquashFS partition 412 may contain read-only user files. The JFFS2 partition 414 may contain configuration files. The SquashFS partition 418 may contain system files.

The measurement of a component according to SPDM is essentially a hash of the content of that particular component. A component can be a single file, multiple files, or even a complete partition. In the BMC, there can be various filesystem layouts and partitions, and measurements can be carried out over files or over each partition.

As shown in FIG. 4, a partition layout can have different types of filesystems mounted. SquashFS filesystems are read-only, whereas JFFS2 or Ext/JFFS filesystems are read-write partitions. Measurements can be performed on different filesystem types.

Similarly, partitions can be mounted on different memory devices, such as SPI flash or eMMC. The BMC firmware aims to capture measurements from both memory devices, allowing for a comparison between the SPI flash measurements and the eMMC partition measurements.

However, a problem arises when measurements are carried out on read-write filesystems, as they are not immutable. When services are loaded, updated, or removed from the filesystem, the measurements change. For example, initially a particular firmware component may have 8 files and a measurement is calculated as follows:

$$Measurement = hash ( file 1 , file 2 , … , file 8 )$$

Subsequently, a new file, “file9,” is added to the filesystem for the particular firmware component. The measurement of the component is accordingly changed to:

$$Measurement - new = hash ( file 1 , file 2 , … , file 9 )$$

In this scenario, if a requester sends a GET-MEASUREMENTS command, the responder will send a new value that the requester is not aware of. This poses a challenge in determining the integrity and trustworthiness of the system, as the requester has no way of knowing what the correct measurement should be.

The BMC firmware aims to capture measurements from both SPI flash and eMMC memory devices, allowing for a comparison between the SPI flash measurements and the eMMC partition measurements. The root filesystem can be hosted on either SPI flash or eMMC devices, and the measurements need to be captured from the respective memory device where the filesystem is mounted.

SPI flash and eMMC are two different types of non-volatile memory commonly used in embedded systems such as BMCs. SPI flash is a type of flash memory that communicates using the Serial Peripheral Interface (SPI) protocol, while eMMC (embedded Multi-Media Controller) is a package consisting of both flash memory and a flash memory controller integrated on the same silicon die.

In the BMC's firmware setup, the root filesystem and other partitions can be flexibly mounted on either SPI flash or eMMC based on the system configuration. For example, the root filesystem and/or SquashFS may be hosted on the SPI flash, while other partitions such as the kernel image may be mounted on the eMMC.

The BMC firmware captures measurements from both SPI flash and eMMC partitions, depending on where the filesystems are located. This allows for a comprehensive assessment of the firmware components, regardless of the underlying memory device.

The main intention of the BMC firmware is to archive that when changes are applied to the firmware, such as adding new files dynamically from the cloud, the measurements remain intact or are advertised in a way that indicates proper installation. This is a challenging problem because it requires changing the parameters of the SPDM measurements while still establishing trust in the updated firmware.

The traditional approach to SPDM measurements assumes a static firmware configuration, where the measurements remain constant. However, in a dynamic scenario where firmware components can be updated or added at runtime, the measurements will change. If there is a difference in the measurements, other devices will refuse to communicate with the BMC, as they will perceive the changes as potentially untrusted.

This presents a dilemma because the goal is to enable dynamic updates to the firmware, such as installing tech packs or containers, to provide flexibility and support to customers. However, these updates inevitably modify the filesystem and alter the measurements. The challenge lies in maintaining the security and integrity of the firmware while allowing for these dynamic changes.

The proposed solution aims to address this problem by rejigging the parameters of the SPDM measurements in a way that preserves trust. Instead of relying solely on static measurements, the approach involves updating the measurement parameters to reflect the trusted changes made to the firmware.

By managing the measurement parameters to accurately represent the updated firmware state, the BMC can establish trust with other devices, even after dynamic updates. This allows for the necessary flexibility to install tech packs, containers, and other firmware components from the cloud, while still maintaining the security and integrity of the system. The goal is that the devices can still communicate with each other securely, despite the changes in the firmware. This requires a mechanism to validate and update the measurement parameters in a trusted manner.

The proposed solution aims to solve this problem by providing a way to dynamically update the SPDM measurement parameters while preserving the trust and security of the firmware. By doing so, it enables the BMC to adapt to runtime changes, install necessary firmware components, and maintain secure communication with other devices in the system.

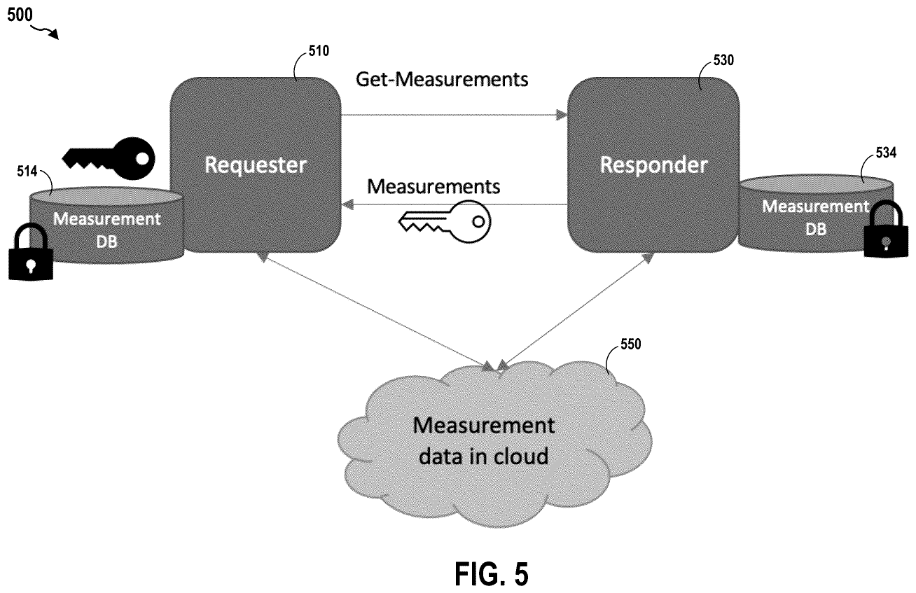

FIG. 5 is a diagram 500 illustrating a process for verifying firmware integrity. A requester 510 sends a GET_MEASUREMENTS command to a responder 530 (e.g., the BMC 102). In certain configurations, the requester 510 may have a local measurements database 514, and the responder may have a local measurements database 534. In certain configurations, the requester 510 and/or the responder may be in communication with a cloud measurements database 550.

The SPDM protocol enables the requester 510 to verify the integrity of the responder 530 by comparing the measurements of the responder's firmware components against known good values. However, when the responder 530 dynamically installs or updates services, the measurements of the read-write filesystems change, making it difficult for the requester 510 to determine the correct measurement values.

To address this issue, in certain configurations, the local measurements database 534 (e.g., a secure table of measurements) is set up in an RPMB (Replay Protected Memory Block) partition on the responder 530, such as the BMC 102. The RPMB partition is a tamper-proof filesystem that can securely store data and can only be accessed with proper keys.

The RPMB partition, which securely stores the measurement data, may be located on the eMMC memory of the BMC 102. This partition is separate from the other partitions that are measured; the measurement data remains secure and tamper-proof. The existence of this secure partition may not be known to users, as it is not part of the regular filesystem. The RPMB partition itself is not included in the measurement process.

During the initial bootup, the responder 530 calculates the measurements of its firmware components and stores them securely in the local measurements database 534 in the RPMB partition or in a secure cloud location, such as the cloud measurements database 550, signed with its private key. The initial measurements of the responder 530 can also be calculated at build time and programmed into the requester 510, which stores the data in its secure storage (e.g., RPMB), such as the local measurements database 514. That is, the requester 510 may have a pre-programmed measurement database, such as the local measurements database 514, which contains the expected measurements for all the devices the requester 510 communicates with in the server. This means that the requester 510 has prior knowledge of the measurements for each device it interacts with.

When a new service is introduced on the responder 530, it calculates the new measurements and stores them in the secure partition or in the remote attestation cloud. Upon receiving a measurement request from the requester 510, the responder 530 sends both the new measurements and the old measurements data.

If the requester 510 is locally verifying the measurements data, it reads the old measurements data from the local measurements database 514. It validates the responder 530 using the old measurements data carried in the response from the responder 530 and the old measurements data retrieved from the local measurements database 514 of the requester 510. Further, upon receiving the new measurements, the requester 510 updates its local measurements database 514 with the new measurements data for subsequent validation. The requester 510 then notifies the responder 530 using a sideband MCTP (Management Component Transport Protocol) command to delete the older measurement information.

If the measurements are stored in the remote attestation cloud, such as the cloud measurements database 550, the requester 510 can retrieve and update measurements data there accordingly.

By storing the measurements securely in the RPMB partition or the cloud measurements database 550, the BMC firmware maintain sanctity of the measurements and prevents tampering. The responder 530 sends both the old and new measurements to the requester 510, allowing for a transition to the updated measurements without compromising the integrity of the system.

The RPMB partition (with the local measurements database 534) serves multiple purposes. It allows the BMC 102 to sync up with the cloud storage device, such as the cloud measurements database 550, enabling the secure storage and retrieval of measurement data. Additionally, if any corruption occurs during firmware updates or flashing, the RPMB partition provides the measurement data that remain intact, allowing the BMC 102 to recover and continue communicating with other devices.

The requester and responder functionality are interchangeable, allowing the responder to become the requester for another device. Since the public key is available with the requester, the encrypted measurement blob can be decrypted and compared with the pre-existing value stored in the requester device or in the remote attestation service in the cloud.

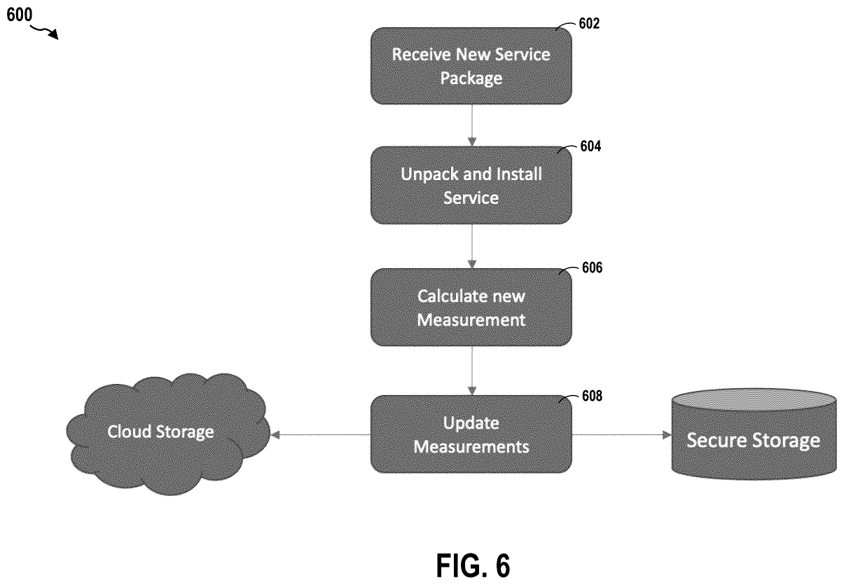

FIG. 6 is a flow chart 600 illustrating a process for managing SPDM firmware measurements. In operation 602, the responder 530, such as the BMC 102, receives a new service package. The new service package contains software components, files, or updates that need to be installed on the responder 530.

In operation 604, the responder 530 unpacks and installs the service from the received package. This involves extracting the necessary files and components from the package and integrating them into the responder's filesystem or firmware.

In operation 606, the responder 530 calculates the new measurements for the installed service. The measurements are typically hash values or cryptographic representations of the installed components. The responder 530 computes these measurements to capture the current state of the firmware after the service installation.

In operation 608, the responder 530 updates the measurements in the local secure storage and/or the cloud storage. The local secure storage may be the local measurements database 534, which can be implemented using an RPMB partition or other tamper-proof storage mechanism. The cloud storage refers to the cloud measurements database 550, where the measurements are securely stored and can be accessed by authorized entities.

After updating the measurements, the responder 530 is ready to respond to measurement requests from the requester 510. When the requester 510 sends a request for measurements, the responder 530 retrieves both the old measurements (prior to the service installation) and the new measurements (after the service installation) from its secure storage. The responder 530 then sends both sets of measurements to the requester 510 for verification.

Upon receiving the measurements from the responder 530, the requester 510 first validates the responder 530 using the old measurements. It compares the old measurements received from the responder 530 with the corresponding values stored in its local measurements database 514. If the old measurements match, the requester 510 can trust that the responder 530 was in a known good state before the service installation or update.

Next, the requester 510 updates its local measurements database 514 with the new measurements received from the responder 530. This update process allows the requester 510 to have the latest expected measurements for the responder 530. By storing the new measurements in its local database, the requester 510 can use them as a reference for future verification of the responder's integrity. Updating the local measurements database 514 enables that the requester 510 stays in sync with the changes made to the responder's firmware.

After updating its local measurements database 514, the requester 510 notifies the responder 530 using a sideband MCTP command to delete the older measurement information. This notification allows the responder 530 to clean up its storage and keep only the latest measurements, reducing storage overhead and maintaining efficiency.

In cases where the measurements are stored in a remote attestation cloud, such as the cloud measurements database 550, the requester 510 can retrieve the updated measurements from the cloud and use them for verification purposes. This allows for a centralized management of measurements and enables multiple requesters to access the same up-to-date measurement values.

By updating its local measurements database 514, the requester 510 maintains a current and accurate view of the expected measurements for the responder 530. This feature enables the ongoing integrity verification of the responder 530, even as services are dynamically installed or updated. It allows the requester 510 to adapt to the changes in the responder's firmware and maintain a secure and trusted relationship with the responder 530.

By following this process, the BMC firmware enables dynamic installation and management of services while maintaining the integrity and trustworthiness of the system through the SPDM measurement mechanism. The use of secure local storage and/or cloud storage protect the measurements from tampering. As such, the measurements can be reliably verified by the requester 510.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operation by a baseboard management controller (BMC), comprising:
receiving, from a requester, a request for a measurement of a firmware component of the BMC;
obtaining a current measurement of the firmware component;
retrieving a previous measurement of the firmware component; and
sending, to the requester, a response containing the current measurement and the previous measurement of the firmware component.

2. The method of claim 1, further comprising:
receiving, from the requester, a notification to delete the previous measurement.

3. The method of claim 1, wherein the current measurement and the previous measurement are stored in a replay protected memory block (RPMB) partition of the BMC.

4. The method of claim 1, wherein the current measurement and the previous measurement are stored in a remote attestation server.

5. The method of claim 1, wherein the current measurement corresponds to the firmware component after a change is made to the firmware component, and the previous measurement corresponds to the firmware component prior to the change being made.

6. The method of claim 1, wherein the firmware component comprises one or more files of the BMC.

7. The method of claim 6, wherein the current measurement is calculated by performing a hash operation on the one or more files of the firmware component after the change is made, and the previous measurement is calculated by performing the hash operation on the one or more files of the firmware component prior to the change being made.

8. The method of claim 1, wherein the firmware component is stored in a Serial Peripheral Interface (SPI) flash memory or an embedded Multi-Media Controller (eMMC) memory of the BMC.

9. The method of claim 1, wherein the request is a GET_MEASUREMENTS command according to a Security Protocol and Data Model (SPDM) standard.

10. The method of claim 1, wherein the response includes a signature generated by signing the current measurement and the previous measurement with a private key of the BMC.

11. The method of claim 1, further comprising:
receiving a new service package;
unpacking and installing the new service package, thereby updating the firmware component;
calculating an updated measurement of the updated firmware component; and
storing the updated measurement as the current measurement.

12. The method of claim 1, wherein the firmware component includes one or more of: a kernel image, a root filesystem, system configuration data, Linux internal filesystem, system libraries, system binaries, and user files.

13. A baseboard management controller (BMC) comprising:
a processor; and
a memory storing instructions that, when executed by the processor, cause the BMC to:
receive, from a requester, a request for a measurement of a firmware component of the BMC;
obtain a current measurement of the firmware component;
retrieve a previous measurement of the firmware component; and
send, to the requester, a response containing the current measurement and the previous measurement of the firmware component.

14. The BMC of claim 13, wherein the instructions further cause the BMC to:
receive, from the requester, a notification to delete the previous measurement.

15. The BMC of claim 13, wherein the current measurement and the previous measurement are stored in a replay protected memory block (RPMB) partition of the BMC.

16. The BMC of claim 13, wherein the current measurement and the previous measurement are stored in a remote attestation server.

17. The BMC of claim 13, wherein the current measurement corresponds to the firmware component after a change is made to the firmware component, and the previous measurement corresponds to the firmware component prior to the change being made.

18. The BMC of claim 13, wherein the firmware component comprises one or more files of the BMC.

19. The BMC of claim 18, wherein the current measurement is calculated by performing a hash operation on the one or more files of the firmware component after the change is made, and the previous measurement is calculated by performing the hash operation on the one or more files of the firmware component prior to the change being made.

20. A non-transitory computer-readable medium storing instructions which when executed by a processor of a baseboard management controller (BMC) cause the BMC to:
receive, from a requester, a request for a measurement of a firmware component of the BMC;
obtain a current measurement of the firmware component;
retrieve a previous measurement of the firmware component; and
send, to the requester, a response containing the current measurement and the previous measurement of the firmware component.
